(19) United States
(12) Patent Application Publication
(10) Pub. No.: US 2005/0132081 A1
(43) Pub. Date: Jun. 16, 2005

(54) Efficient protocol processing to increase bandwidth in interrupt mode

(75) Inventors: Chulho Kim, Poughkeepsie, NY (US); Hanhong Xue, Poughkeepsie, NY (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/733,725

(22) Filed: Dec. 11, 2003

(51) Int. Cl. G06F 15/16

(52) U.S. Cl. 709/231

(57) ABSTRACT

A communication system with a communications adapter operating in an interrupt mode, the system comprising: a network system with at least one sender and a recipient of a message and a network for communication therebetween; the communications adapter placing data from the message in a receive buffer and generating an interrupt; and a state variable configured to track received messages. A method for increasing bandwidth in an interrupt mode processing protocol comprising: creating a state variable configured to track received messages; incrementing the state variable only if the received message exhibits multiple packets; decrementing the state variable if the received message exhibits multiple packets and completes; and generating an interrupt, with a communications adapter running in an interrupt mode, the communications adapter placing data from received message in a receive buffer.

### BACKGROUND OF THE INVENTION

The present invention relates generally to communications in a computer network and is more particularly related to enhancing bandwidth in an interrupt handler when the interrupt handler received an interrupt from a communications adapter.

Existing interrupt handlers poll for set amount of time in the when an interrupt has occurred to reduce number of interrupts generated for packets in flight. This fixed polling duration may add latency for some messages. For some applications, high interrupt bandwidth and low latency is needed to achieve satisfactory performance.

In some instances, because of the gap of packets sent out by certain adapters from the send side, a large number of interrupts are generated on the receiving side. One way to address this problem is simply increasing the loop time employed by the interrupt handler. However, this alone may not improve application runtime because often only single packets are sent and latency is increased. Especially, for example, when the application does its own synchronization using a low level applications programming interface (LAPI) and the like. Therefore, what is needed in the art is way to stabilize the bandwidth performance where multiple packets in the network are far apart relative to the processing speed of the protocol on the receiving side and cause multiple interrupts, and yet does not impact bandwidth for the single packet case.

### BRIEF SUMMARY

The above-discussed and other drawbacks and deficiencies of the prior art are overcome or alleviated by an exemplary embodiment of a communication system with a communications adapter operating in an interrupt mode, the system comprising: a network system with at least one sender and a recipient of a message and a network for communication therebetween; the communications adapter placing data from the message in a receive buffer and generating an interrupt; and a state variable configured to track received messages.

Disclosed herein in yet another exemplary embodiment is the system above wherein: the state variable is incremented only if a multi-packet message is received; the state variable is decremented if the multi-packet message completes. This system also includes an interrupt handler exiting only if: there are no more packets in the receive buffer; and at least one of: the state variable is equal to a selected value and a selected interval has transpired since the interrupt was generated.

Also disclosed herein in another exemplary embodiment is a method for increasing bandwidth in an interrupt mode processing protocol comprising: creating a state variable configured to track received messages; incrementing the state variable only if the received message exhibits multiple packets; decrementing the state variable if the received message exhibits multiple packets and completes; and generating an interrupt, with a communications adapter running in an interrupt mode, the communications adapter placing data from received message in a receive buffer.

Further disclosed herein in yet another exemplary embodiment is the method above further including exiting an interrupt handler if there are no more packets in the receive buffer; and at least one of: the state variable is equal to a selected value and a selected interval has transpired since the interrupt was generated.

Also herein in yet another exemplary embodiment is a storage medium encoded with a machine-readable computer program code, the code including instructions for causing a computer to implement the above-mentioned method for increasing bandwidth in an interrupt mode processing protocol.

### BRIEF DESCRIPTION OF THE DRAWINGS

These and other objects and advantages of the present invention may be best understood by reading the accompanying detailed description of the exemplary embodiments while referring to the accompanying figures wherein like elements are numbered alike in the several figures in which:

FIG. 1 is a diagrammatic view depicting a network communication system in accordance with an exemplary embodiment; and

FIG. 2 is a partial diagrammatic depiction of message communication among a sender and several recipients in accordance with an exemplary embodiment.

The detailed description explains the preferred embodiments of our invention, together with advantages and features, by way of example with reference to the drawings.

### DETAILED DESCRIPTION OF THE EXEMPLARY EMBODIMENTS

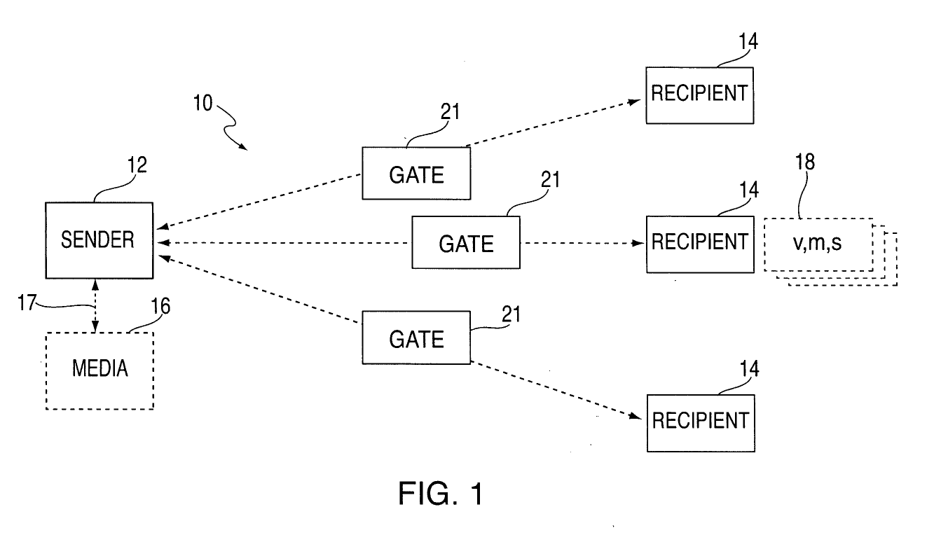

Referring now to FIG. 1, a network communication system 10 in accordance with an exemplary embodiment is depicted. The network communication system 10 includes, but is not limited to, a at least two machines 12, 14 denoted here as sender system 12 and various recipient systems 14 interconnected via various communications means e.g., network to facilitate information transfer. The network communication system 10 may be employed for various communications, including but not limited to instant messaging, email, data, voice, and image transmittal, internet services, and the like, as well as combinations including at least one of the foregoing. Each sender 12 and/or recipient system 14 may be a general-purpose computer that is interfaced to a network system e.g., Internet service provider, email system and the like and includes operating system software and any other suitable programs that reside in memory and execute on sender system 12 and recipient system 14. It will be understood by those skilled in the art that the network communication system 10 may be executed on computer systems with variant architectures. Sender 12 and recipient may be in communication with host system that may also be a server system via a network connection such as the Internet, Intranet, LAN, WAN, or other suitable means of networking architecture. While only one is shown, it will be understood that any number of senders 12 and recipients 14 may be used in order to realize the advantages of the described embodiments. In one embodiment, a recipient executes a communications protocol that allows a recipient system 14 to enhance bandwidth associated with network communications.

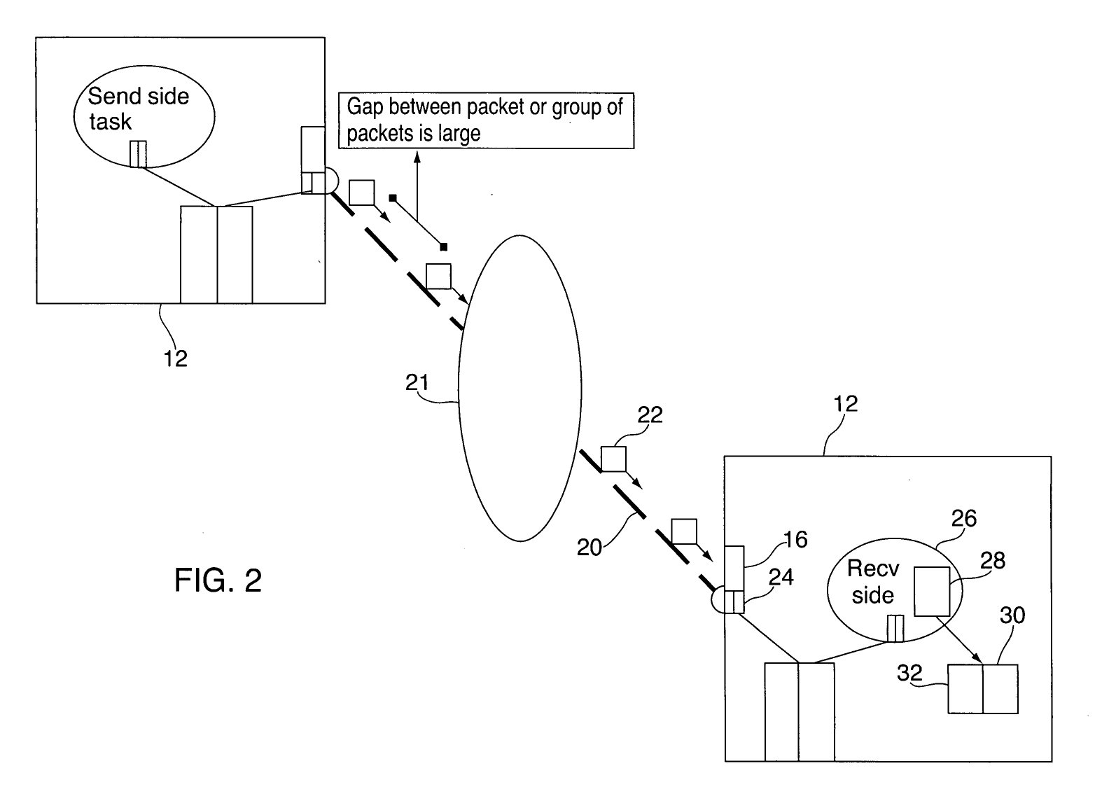

Referring now to FIG. 2 as well, in an exemplary embodiment the above-mentioned limitations of existing computer networks and communications systems 10 employing communications adapters 16 operating in an interrupt mode are addressed by establishing a state variable 18 in a receiving computer system 14. As a message 20 is transmitted to a recipient 14 from a sender 12 and may be via a gateway or switch 21. The message 20 may include one or more packets 22. The message 20 is received at the adapter 16 and all packets 22 are decoded and the data therein loaded into a storage buffer 24. In and exemplary embodiment, a first in first out FIFO buffer 24 is employed, however other configurations are possible and considered. Furthermore, in an exemplary embodiment, the adapter 16 generates an interrupt to inform the low level applications programming interface (LAPI) 26, or other input/output handling interfaces, and the like that there is data in to buffer 24 ready for applications use. An interrupt handler 28 is configured to control moving data out of the adapter buffer 24 to user storage, and the like, so that a CPU 32 or user e.g. 30 can access the data. In existing systems, when the buffer 24 has been emptied, the interrupt handler 28 ensures that control is returned to the user application software denoted in the figure as reference numeral 30.

Continuing now to FIG. 2, in an exemplary embodiment the above-mentioned limitations of existing computer networks and communications systems 10 employing communications adapters 16 operating in an interrupt mode are addressed by establishing one or more state variable(s) 18 in a receiving computer system 14. The state variable(s) 18 configured to track the characteristics of received messages 20. In one exemplary embodiment, state variable 18 tracks how many received messages 20 exhibit multiple packets 20. However a state variable 18 may be employed to track, monitor and the like any and all characteristics of a received message 20.

As a message 20 is received, if the message 20 is determined to exhibit multiple packets 22, the state variable 18 is incremented. For example, the state variable 18 could function as counter, initialized to zero with the initiation of communication and incremented by one (1) for each message 20 received with multiple packets. A message 20 with only a single packet need not increment the state variable 18.

Furthermore, in an exemplary embodiment, if a received message 20 that has multiple packets 22 completes (i.e., all packets are received by the adapter 16 and loaded into a storage buffer 24 then the state variable 18 is decremented by one (1). As the interrupt is generated, to initiate parsing data from the buffer 24, in an exemplary embodiment a conditional loop based on the following conditions is employed in the interrupt handler 28 to establish constraints on returning processing control to the user application. For example, in one exemplary embodiment the interrupt handler 28 is exited only if: there are no more packets 22 in the receive buffer 24 and at least one of: the state variable 18 is equal to a selected value and a selected interval has transpired since said interrupt was generated. Therefore, a determination is made as to whether there are there more packets in the buffer 24, if so, the interrupt continues. In an exemplary embodiment, the selected interval is selected to be large with respect to the CPU 32 speed. In one instance, a selected interval on the order of about 100 milliseconds may be employed.

Therefore, in other words, if there is no data in the receiving FIFO buffer 24 and either or both, the state variable 18 is equal to zero (0), or the selected polling interval has expired then processing can exit the interrupt handler 28 and return CPU 32 processing to the user application 30. In the instance that the buffer 24 does not empty within the selected duration for the polling loop, a mechanism to terminate the interrupt handler 28, returning processing to the application code 30 to run before another interrupt is generated. Advantageously this approach permits the application 30 to progress even as messages 20 are being intermittently received by the adapter 16. Depending on how the application 30 is written and behaves there may be instances where significant benefits to communications bandwidth and/or applications 30 processing may be achieved. Especially for example, with applications 30 that are one-sided e.g., interrupt driven, with messages 20 that span multiple packets 22.

Therefore, it will be appreciated, that in certain instances, a balance may be established between processing communication messages 20 and application 30 processing. In one instance the balance may optimize communications throughput or bandwidth, while in others, it may optimize applications 30 processing. It will be appreciated the other factors, parameters, and the like for the selected polling interval may also be considered to establish the above-mentioned balance.

In yet another exemplary embodiment, one or more state variable(s) 18 may be employed to track various aspects of the received messages 20, sender 12, and the like. In addition, the state variable 18 may be namespaced based upon the sender 12 (to avoid multiple senders 12 impacting another's state variable 18 on various recipient's machines). For example, in one exemplary embodiment, a state variable 18 may be characterized by or a function of several parameters. The parameters may include, but not be limited to, state variable(v, m, s) 18 where v is the state variable name, m is the characteristic of the message 20 to which the state variable v 18 applies, and s is the sender 12 that controls the behavior of state variable v 18.

It will also be appreciated that in one embodiment the state variables 18 are expected to be stored on the recipient system 14. In an alternative embodiment, it should be appreciated that the state variables(v, m. s) 18 could also be part of the message 20 and include additional information or characteristics pertaining to the message 20.

In order to perform the prescribed functions and desired processing, as well as the computations therefore (e.g., the facilitate communications among various senders 12 and recipients 14, and the like), the sender 12 and/or recipient(s) 14 may comprise a computer system including central processing unit (CPU) 32, monitor, storage and the like. The computer system may include, but not be limited to, a processor(s), computer(s), memory, storage, register(s), timing, interrupt(s), communication interface(s), and input/output signal interfaces, and the like, as well as combinations comprising at least one of the foregoing. For example, computer system may include signal input/output for controlling of communications switches as described herein. Additional features of a computer system and certain processes therein may be disclosed at various points herein.

It will be appreciated that when the term message as employed herein is intended to imply any communication sent over a network communication system 10 including, but not limited to, one-on-one messages, group chat invitations, audio, video, and file transfers, among others.

The processing performed throughout the network communications system 10 may be distributed in a variety of manners. For example, distributing the processing performed in a sender 12 or recipient 14 and among the other processors employed therein. Such distribution may eliminate the need for a particular component or process as described or vice versa, combining distributed processes in a various computer systems. Each of the elements described herein may have additional functionality that will be described in more detail herein as well as include functionality and processing ancillary to the disclosed embodiments. As used herein, signal connections may physically take any form capable of transferring a signal, including, but not limited to, electrical, optical, or radio.

The disclosed invention can be embodied in the form of computer, controller, or processor implemented processes and apparatuses for practicing those processes. The present invention can also be embodied in the form of computer program code containing instructions embodied in tangible media 16 such as floppy diskettes, CD-ROMs, hard drives, or any other computer-readable storage medium, wherein, when the computer program code is loaded into and executed by a computer, controller, or processor 12, 14, the computer, controller, or processor 12, 14 becomes an apparatus for practicing the invention. The present invention may also be embodied in the form of computer program code as a data signal 17 for example, whether stored in a storage medium, loaded into and/or executed by a computer, controller, or processor 12, 14 or transmitted over some transmission medium, such as over electrical wiring or cabling, through fiber optics, or via electromagnetic radiation, wherein, when the computer program code is loaded into and executed by a computer 12, 14, the computer 12, 14 becomes an apparatus for practicing the invention. When implemented on a general-purpose processor the computer program code segments configure the processor to create specific logic circuits.

It will be appreciated that the use of first and second or other similar nomenclature for denoting similar items is not intended to specify or imply any particular order unless otherwise stated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A communication system with a communications adapter operating in an interrupt mode, the system comprising:
a network system with at least one sender and a recipient of a message and a network for communication therebetween;
said communications adapter placing data from said message in a receive buffer and generating an interrupt; and
a state variable configured to track received messages.

2. The system of claim 1 wherein:
said state variable is incremented only if a multi-packet message is received;
said state variable is decremented if said multi-packet message completes;
an interrupt handler exiting only if: there are no more packets in said receive buffer; and at least one of: said state variable is equal to a selected value and a selected interval has transpired since said interrupt was generated.

3. The system of claim 2 wherein said selected interval is about 100 milliseconds.

4. The system of claim 1 wherein said state variable tracks a number of packets in said received message exhibiting multiple packets.

5. The system of claim 1 wherein said received messages exhibiting a single packet are ignored with respect to said state variable.

6. The system of claim 1 wherein said state variable is created in said recipient.

7. The system of claim 1 wherein said state variable is namespaced based on a selected sender of a message.

8. The system of claim 1 wherein said state variable is includes at least one of a function and one or more parameters.

9. The system of claim 8 wherein said parameters include at least one of a state variable name, a sender, and a message.

10. A method for increasing bandwidth in an interrupt mode processing protocol comprising:
creating a state variable configured to track received messages;
incrementing said state variable only if said received message exhibits multiple packets;
decrementing said state variable if said received message exhibits multiple packets and completes; and
generating an interrupt, with a communications adapter running in an interrupt mode, said communications adapter placing data from received message in a receive buffer.

11. The method of claim 10 further including:
exiting an interrupt handler only if: there are no more packets in said receive buffer; and at least one of: said state variable is equal to a selected value and a selected interval has transpired since said interrupt was generated.

12. The method of claim 11 wherein said selected interval is about 100 milliseconds.

13. The method of claim 10 wherein said state variable tracks a number of packets in said received message exhibiting multiple packets.

14. The method of claim 10 wherein said received messages exhibiting a single packet are ignored with respect to said state variable.

15. The method of claim 10 wherein said state variable is created in said recipient.

16. The method of claim 10 wherein said state variable is namespaced based on a selected sender of a message.

17. The method of claim 10 wherein said state variable is includes at least one of a function and one or more parameters.

18. The method of claim 10 wherein said parameters include at least one of a state variable name, a sender, and a message.

19. A storage medium encoded with a machine-readable computer program code, said code including instructions for causing a computer to implement a method for increasing bandwidth in an interrupt mode processing protocol, the method comprising:
creating a state variable configured to track received messages;
incrementing said state variable only if said received message exhibits multiple packets;
decrementing said state variable if said received message exhibits multiple packets and completes; and
generating an interrupt, with a communications adapter running in an interrupt mode, said communications adapter placing data from received message in a receive buffer.

20. The storage medium of claim 19 further including code including instructions for causing a computer to implement a method for increasing bandwidth in an interrupt mode processing protocol, the method further including:
exiting an interrupt handler only if: there are no more packets in said receive buffer; and at least one of: said state variable is equal to a selected value and a selected interval has transpired since said interrupt was generated.
